(19) United States
(12) Patent Application Publication
(10) Pub. No.: US 2023/0011808 A1
(43) Pub. Date: Jan. 12, 2023

(54) FULL NEEDLE PENETRATION ON CONVEYOR BELT INJECTOR

(71) Applicant: John Bean Technologies Corporation, Chicago, IL (US)

(72) Inventor: Dale R. Hunt, Sandusky, OH (US)

(73) Assignee: John Bean Technologies Corporation, Chicago, IL (US)

(21) Appl. No.: 17/858,677

(22) Filed: Jul. 6, 2022

Related U.S. Application Data
(60) Provisional application No. 63/218,871, filed on Jul. 6, 2021.

(51) Int. Cl. A22C 9/00; A23L 13/70

(52) U.S. Cl. CPC A22C 9/001; A23L 13/72

(57) ABSTRACT

An injection machine includes a needle assembly including a plurality of injector needles arranged into a pattern to cover a horizontal injection area, the injector needles include side exit ports located proximally with respect to a tip of the needle. The injection machine also includes a conveyor positioned below the needle assembly. Particularly, the conveyor includes perforations on a top surface of the conveyor, wherein the perforations allow the plurality of injector needles to be lowered to place the side exit ports of the injector needles at or just above the top surface of the conveyor.

### CROSS-REFERENCE TO RELATED APPLICATION

This application claims the benefit of U.S. Provisional Application No. 63/218,871, filed Jul. 6, 2021, the contents of which are fully incorporated herein expressly be reference for all purposes.

### SUMMARY

In one embodiment, an injection machine comprises a needle assembly including a plurality of injector needles arranged into a pattern to cover a horizontal injection area, the injector needles include side exit ports located proximally with respect to a tip of the needle; and a conveyor positioned below the needle assembly, wherein the conveyor includes perforations on a top surface of the conveyor, wherein the perforations allow the plurality of injector needles to be lowered to place the side exit ports of the injector needles at or just above the top surface of the conveyor.

In one embodiment, the conveyor is an endless loop belt conveyor.

In one embodiment, the tips of the injector needles travel below the top surface of the conveyor on a downstroke of the needle assembly.

In one embodiment, the injection machine further comprises a control system configured to control the forward advance speed of the conveyor and synchronize the lifting and lowering of the needle assembly with the advance of the conveyor.

In one embodiment, an injector needle is a hollow tube ending in a sharp tip, wherein the tip is closed, and the injector needle has a plurality of side exit port about 4 mm to about 5 mm proximally above the end of the tip and around the circumference of the injector needle.

In one embodiment, the perforations in the conveyor at least match the pattern of the plurality of injector needles.

In one embodiment, the conveyor includes perforations on the top surface in addition to perforations that match the pattern of the plurality of injector needles.

In one embodiment, the conveyor includes perforations on the top surface that match the patterns of two or more needle assembly patterns.

In one embodiment, the perforations in the conveyor are only as deep as a distance between the tip of the injector needle to an edge of the side exit port, and a horizontal dimension of the perforations are at least equal to or greater than a diameter of the injector needles.

In one embodiment, the injection machine further comprises a control system configured to control a timing of injecting fluid via the injector needles.

In one embodiment, a method of injection of an ingredient in a food product with an injection machine comprising a needle assembly including a plurality of injector needles arranged into a pattern to cover a horizontal injection area, the injector needles include side exit ports located proximally with respect to a tip of the needle and a conveyor belt positioned below the needle assembly, wherein the conveyor belt includes perforations on the surface of the conveyor belt, the method comprises lowering the needle assembly during injection of the ingredient into the food product, wherein the perforations allow the plurality of injector needles to be lowered to place the side exit ports of the injector needles at or just above a top surface of the conveyor belt.

In one embodiment, the food product is a low profile food product.

In one embodiment, the ingredient includes brine, spices, flavors, marinade, or combination thereof.

In one embodiment, the method further comprises advancing the conveyor in increments of at least 100 mm.

In one embodiment, the method further comprises advancing the conveyor in increments of at least 200 mm.

In one embodiment, the method further comprises synchronizing the injection of ingredient into the food product with the advance of the conveyor belt.

In one embodiment, the method further comprises controlling dispensing of the ingredient from the side exit ports to include injection throughout a thickness of the food product including at the lower portions of the food product.

In one embodiment, a method of making an injection machine that comprises a needle assembly including a plurality of injector needles arranged into a pattern to cover a horizontal injection area, the injector needles include side exit ports located proximally with respect to a tip of the needle and a conveyor belt is positioned below the needle assembly, the method comprises replacing the conveyor belt with a conveyor belt that includes perforations on the top surface of the conveyor belt, wherein the perforations allow the plurality of injector needles to be lowered to place the side exit ports of the injector needles at or just above the top surface of the conveyor belt.

In one embodiment, the conveyor includes a pattern of perforations on the top surface that match at least one pattern of injector needles of the needle assembly.

In one embodiment, perforations are added to the conveyor for retro-fitting of the injection machine.

In one embodiment, an injection machine comprises a needle assembly including a plurality of injector needles configured to inject an ingredient into a food product over a horizontal area and throughout the thickness of the food product, wherein the needle assembly is configured to be lowered and raised; a conveyor below the needle assembly, wherein a top surface of the conveyor allows the injector needles to be lowered partly below the top surface of the conveyor; and a control system configured to advance the conveyor in increments corresponding to the horizontal area of the needle assembly.

In one embodiment, the control system is configured to lower the needle assembly according to a vertical motion profile for the needle assembly.

In one embodiment, the vertical motion profile can be adjusted to control the rate of insertion or extraction of the injector needles.

In one embodiment, the injector needles are arranged into one or more rows, and the conveyor advances in increments corresponding to the number of rows.

In one embodiment, the top surface of the conveyor includes perforations at least in a pattern corresponding to the injector needles.

In one embodiment, the injection machine comprises a conveyor belt made of modular plastic lengths laced together with steel rods.

In one embodiment, the control system calculates the position of the conveyor based on detection of steel rods in the conveyor.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of an injection machine with a conveyor belt;

FIG. 2 is a schematic illustration of an example of a conventional side exit port injector needle used for injection on food products;

FIG. 3 is a schematic illustration of the conventional side exit port injector needle of FIG. 2 used with an example of a perforated conveyor belt according to the disclosure;

FIG. 4 is a schematic illustration of an example of a perforated conveyor belt in a needle pattern for 200 mm advances;

FIG. 5 is a schematic illustration of an example of a perforated conveyor belt in a needle pattern for 100 mm advances; and

FIG. 6 is a schematic illustration of a control system for controlling the needle assembly and conveyor.

### DETAILED DESCRIPTION

Brine injection is performed by walking beam machines and conveyor belt machines. Injection of brine, spices, flavors, marinade, or other ingredients for food products can be performed automatically in either one of the walking beam machine or the conveyor belt machine on a large number of food products with a needle assembly comprising a plurality of hollow needles having a side exit ports.

Injection via side exit port needles results in a satisfactory appearance in a low profile food product. However, because the side exit ports do not fully travel to the lowest portion in the food product, the portion of the food product that is below the side exit ports of the needle is distinguishable in the cooked product. Injection via side exit port needles allows brine or marinade dispersion from the top to the bottom of the substrate.

Deeper needle penetration so that the side exit ports reach the lowest portion on the food product is possible on a walking beam injector. However, this style of injector is not advantageous, because the throughput on a walking beam machine is less compared to a conveyor belt machine, and when low profile products, such as meat or plant based nuggets or tenders, are attempted to be injected on a walking beam machine, the low profile products could get caught between the rails, thereby causing failure to transport the low profile products forward. Accordingly, this disclosure solves a problem relating to the injection of ingredients into food products with side exit port injector needles using a conveyor belt injection machine.

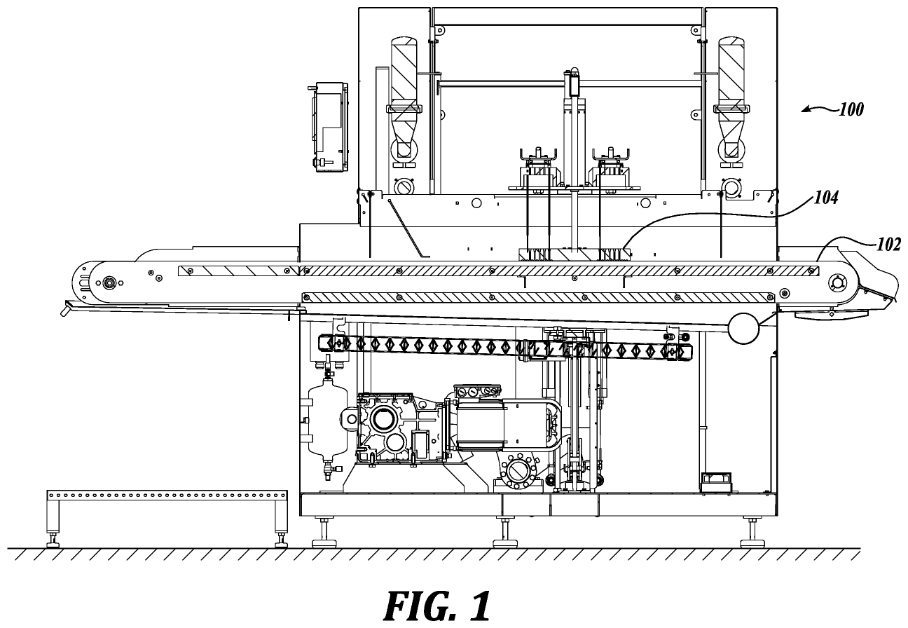

FIG. 1 is a diagrammatical illustration of an injection machine 100 with a conveyor 102. In an example, the conveyor 102 is a conveyor belt. A conveyor belt 102 can be made from food grade polymer or plastic with interwound fabric or steel wire for strength. The conveyor belt 102 can be flexible when made from polymer materials strengthened with fabric or steel wire. In other examples, the conveyor 102 can include rigid polymer or steel links that are connected to one another to provide flexing at the linkages. In an example, the injection machine 100 includes an endless loop belt conveyor 102 driven by at least one drive roller and motor. The top surface of the conveyor belt 102 is generally horizontal and can rest on a supporting structure, such as a flat table.

The injection machine 100 includes one or more needle assemblies 104 positioned above the conveyor belt 102. The needle assembly 104 is connected to a lifting and lowering apparatus so as to lower and raise the needle assembly 104 each time the conveyor advances. A needle assembly 104 includes a plurality of needles arranged vertically side by side in a pattern to cover a larger horizontal area of injection so that several of the plurality of needles can penetrate the surface of food products placed on top of the conveyor 102.

The needle assembly 104 and the individual needles are provided with the brine, marinade, or other ingredient via a dispensing apparatus. The needle assembly 104 can be raised and lowered as required by the lifting and lowering apparatus under the control of a processor. The processor can also be used control the timing of a pump to supply the injection fluid to the injector needles so that the fluid exits the injector needles from the side exit ports just before or immediately when the side exit ports first enters the food product, and continues to inject fluid during the down stroke of the needle assembly until stopping at the lowest point of travel.

The processor can also be used to control the advance speed of the conveyor belt 102. The needle assembly 104 is capable of injecting the food products on the conveyor 102 by synchronizing the linear speed of the conveyor 102 with the lifting and lowering of the needle assembly 104 so that food product does not pass without being injected. In one example, the advance of the conveyor belt 102 is on the order of 100 mm or 200 mm per one cycle of lifting and lowering of the needle assembly 104.

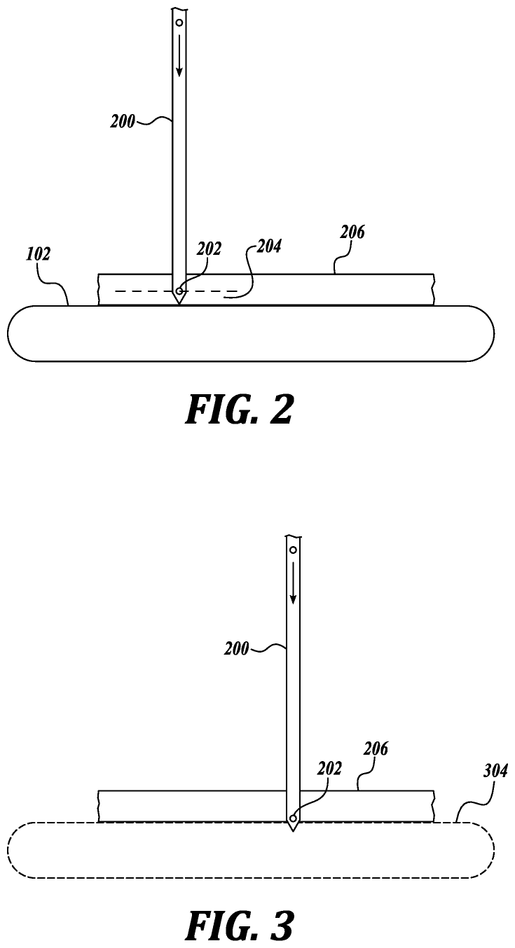

A typical injector needle 200 of the needle assembly 104 is illustrated in FIG. 2. A single injector needle 200 is illustrated; however, it is understood that the needle assembly 104 includes a plurality of such illustrated injector needles 200. The injector needle 200 is made from a stainless steel hollow tube with a pointed tip welded in place. The tip is closed so that fluid does not exit through the tip at the end. Instead, just proximally above the tip there are a plurality of side exit ports 202 around the circumference of the needle 200 from which the marinade is delivered. The side exit ports 202 are approximately 4 mm to 5 mm from the tip or end of the needle 200 and spaced generally equally around the circumference. The distance from the tip to the side exit ports 202 means it is not possible to inject marinade into the lowest part of the food product 206, represented by the space 204 below the dotted line, and thereby compromising marinade dispersion in the food product 206. For example, if the food product 206 is 11 mm thick, about 36% along the thickness of the food product 206 is not injected with the marinade. Furthermore, the needles 200 cannot travel any lower as they will hit the top of the conveyor belt 102.

To overcome the problem of side exit port injector needles 200 on conveyor belt 102, FIG. 3 is an illustration of the same injector needle 200 with the side exit ports 202 being from 4 mm to 5 mm above the tip. However, FIG. 3 illustrates a perforated conveyor belt 304 to replace the conveyor belt 102, thus, allowing the injector needles 200 to travel 4 mm to 5 mm further into the top surface of the perforated conveyor 304 such that the needle tips travel below the surface of the conveyor belt 304, and the side exit ports 202 are placed at or just above a top surface of the conveyor belt 304 at the end of the bottom stroke of the lowering cycle.

The conveyor belt 304 is perforated in a pattern that at least matches the needle arrangement of the needle assembly 104. The conveyor belt 304 is synchronized with the needle pattern and has perforations in the belt 304 matching this needle pattern. The injector needles will then travel 4 mm to 5 mm lower (traveling into the belt 304) to position the needle side exit ports 202 level with the top surface of the conveyor belt 304 or at the lowest part of the food product 206. Herein, perforations can mean holes extending throughout the thickness of the conveyor belt 304. However, the perforations in the conveyor belt 304 do not need to penetrate entirely through the thickness of the conveyor belt 304. In an example, the conveyor belt 304 can include perforations that are small depressions or dimples formed on the surface of the conveyor belt 304, without extending completely through the conveyor belt.

In an example, the perforations in the conveyor belt 304 only need to be deep enough so that that side exit ports 202 or an edge of the side exit ports 202 becomes aligned to the top surface of the conveyor 304 or that the side exit port 202 travels through the entire thickness of the food product 206 without leaving a region that is not injected with fluid. Therefore, the processor can control the depth of injection in any range from the top to the bottom of the food product 206.

Additionally, the perforations in the conveyor belt 304 can have any irregular or regular shape as long as allowing penetration of the tip of the injector needles 200 below the top surface of the conveyor 304. The smallest horizontal dimension of the perforations on the top surface of the conveyor belt 304 can be equal to or greater than the diameter of the injector needles. While 4 mm to 5 mm is representative of one example of the distance between the distal tip of the injector needle 200 to the edge of the side exit ports 202, it is possible that the injector needles 200 can travel more or less depending on where the side exit ports 202 are located with respect to the tip end. Accordingly, the depth of the perforations in the conveyor belt 304 can correspond to the difference in height from the distal tip of the injector needle 200 to the edge of the side exit ports 202.

An example of a food product 206 is a low profile product. Low profile products include foods, such as tofu, plant based meat alternatives to chicken, beef, fish, and pork, bacon, split chicken breasts, and others. Low profile products are growing rapidly and benefit from injection using the side exit port injection needles 200. Further, the side exit port needles give the optimum appearance in the low profile food substrate. A low profile food substrate can be very thin. Some examples of low profile food products can weigh only 23 lbs. per square meter. A way to achieve high processing of low profile food products on a conveyor belt injection machine with 100 mm or 200 mm advance includes perforating the conveyor belt 102 or providing depressions to match the needle pattern or replacing a nonperforated conveyor belt 102 with a perforated or dimpled conveyor belt 304.

It is possible that the conveyor belt 304 is made with a screen type material that has many more perforations than the needle pattern of the needle assembly 104, but the screen nevertheless includes perforations to match the needle pattern. Furthermore, by including greater numbers of perforations in the conveyor belt 304 can allow for replacing needle assemblies having different needle patterns. For example, a needle assembly may use two or more different needle patterns. In such case, the conveyor belt 304 has perforations to match the two or more different needle patterns, such that replacing conveyor belt 304 is unnecessary when changing needle assemblies.

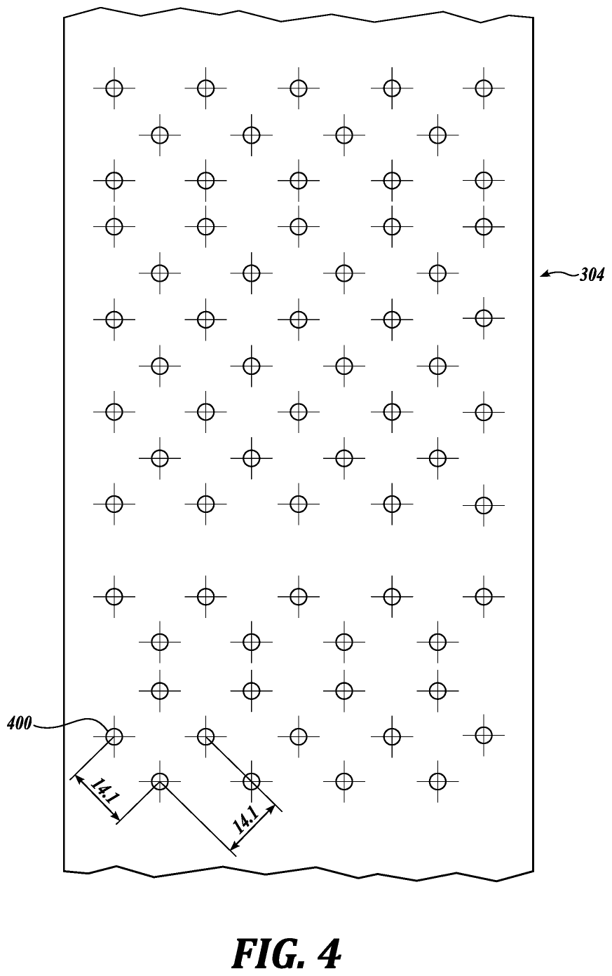

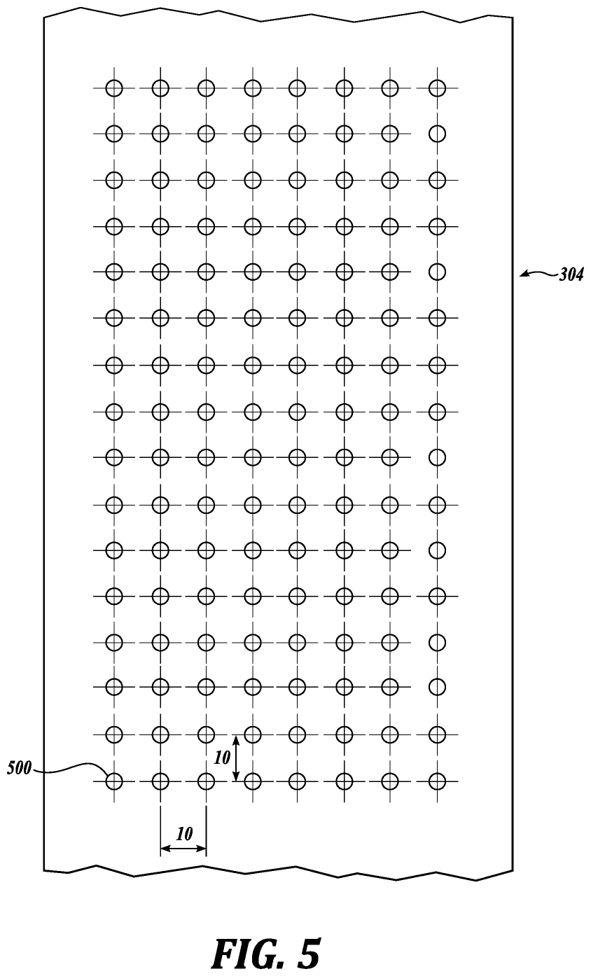

FIG. 4 is one example of perforations 400 of the conveyor belt 304 to match a needle pattern for 200 mm conveyor advances, and FIG. 5 is one example of perforations 500 of the conveyor belt 304 to match a needle pattern for 100 mm conveyor advances. It can be seen that the density of perforations 400 for 100 mm advances is higher than the density of perforations 500 for 200 mm advances. In FIGS. 4 and 5, the dimensions between perforations 400 and 500 are given in millimeters.

If, for example, the conveyor belt 304 is to accommodate both needle patterns for 100 mm and 200 mm advances, the conveyor belt 304 can have perforations to synchronize with both needle patterns. In other words, the perforations in the conveyor belt 304 accommodate both needle patterns of FIGS. 4 and 5, such that both of the patterns are overlapped onto the surface of the conveyor belt 304 to determine the placement of the perforations.

In addition to low profile food products, the injection machine with the conveyor belt 304 perforated to match the needle pattern can be used for smaller food products and products that have a low profile (i.e., thickness) like nuggets or tenders of either fresh meat or plant based products.

Having an accurately positioned conveyor belt that matches the needle pattern will allow a needle to travel below the conveyor belt and have the side exit ports of the needle deliver solution to about or nearly 100% throughout the thickness of the substrate. The full height product injection with side ported needles can be used for any product.

To improve the yield in the plant based meat product, the trim could be re-milled and injected along with the marinade into the product. In one example, full height product injection can be used for injection of high biological value (HBV) protein foods. In another example, full height product injection can be used for milled plant based meat trim. In another example, full height product injection can be used for any food requiring injection of an ingredient.

Existing injection machines with conveyor belts can be retro-fitted by replacing the existing non-perforated conveyor belt with a perforated conveyor belt or the existing non-perforated conveyor belt can be modified by adding the perforations and then re-installed onto the injection machine.

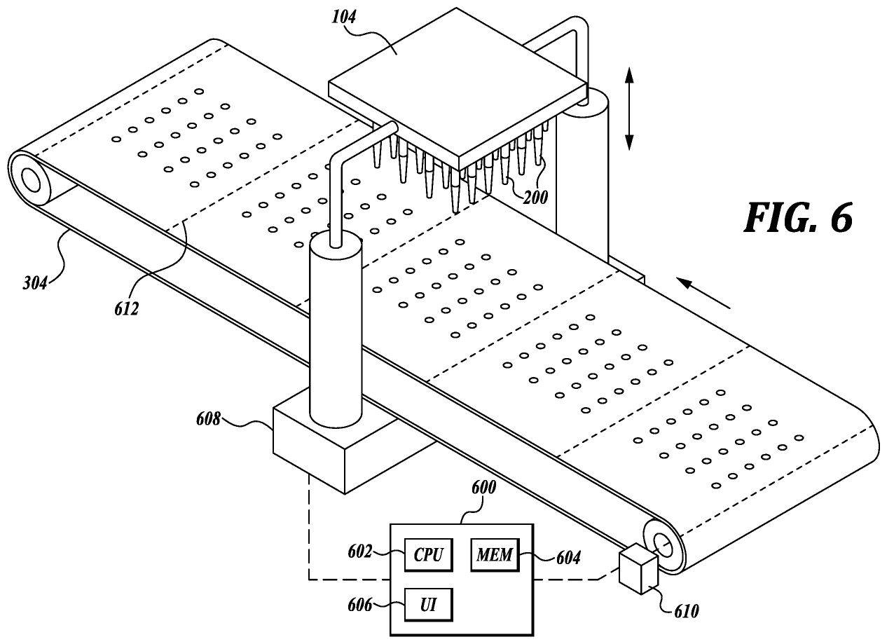

Referring to FIG. 6, a schematic illustration of a control system for synchronizing the needle assembly 104 to the conveyor 304 is illustrated. Needle assembly 104 comprises an array of needles 200 extending vertically. The injector needles can be placed along rows and columns to cover a horizontal area for injection. The needle assembly 104 is actuated vertically for lowering and lifting by a servo-system 608. The servo-system 608 includes, for example, a first and second hydraulic cylinder supporting the needle assembly 104.

The conveyor 304 includes a top surface that allows the injector needles 200 to be lowered below the top surface of the conveyor 304 which places the side exit ports of injector needles 200 at the surface of the conveyor to allow full height injection of food products. In one example, the conveyor 304 includes perforations on the top surface of the conveyor 304, wherein the perforations are arranged in a pattern similar to the array of needles 200 of the needle assembly 104. The conveyor 304 includes multiple patterns of the perforations extending throughout the length of the conveyor 304.

The computer control system 600 is configured to precisely advance the conveyor 304 such that the advance of the conveyor can stop precisely at an integer number of needle rows corresponding to the number of needles 200 on the needle assembly 104.

The conveyor 304 is driven by a servo motor roll 610 with internal encoder. The internal encoder allows calculation of the conveyor 304 position. In one example, the conveyor 304 can be a modular plastic belt laced together with steel rods 612. The rods 612 are detected to calculate when the conveyor 304 is in the right position, which allows precisely positioning the perforations underneath the needle assembly 104.

Both of the servo-system 608 and the servo motor roll 610 are under control by the computer system 600 including, for example, a central processing unit 602, a storage memory 604, and a user interface 606. The central processing unit 602 performs a series of logic instructions stored in the memory 604. The memory 604 can include predetermined information for operation of the needle assembly 104 and the conveyor 340. Additionally, operational information that can be input or changed according to input provided by a user on the user interface 606.

For example, if the conveyor 304 has a 10 mm pitch in the direction of belt travel, the control system 600 allows a user to select the desired stroke length and stroke rate and approximate belt advance (or capacity and bed depth) via the user interface 606. The central processing unit 602 will then automatically solve the motion control parameters such that the conveyor 304 advances an “n” number of needle rows and the needle assembly 104 then moves down into the product and back up. The internal encoder of the servo motor roll 610 communicates the position of the conveyor 304 to the central processing unit 602.

The servo-system 608 uses servo motors to control the rate of vertical motion and the vertical axis of control can be electronically coupled to the servo motor roll 610 which provides the capability for precision advance of the conveyor such that the advance of the conveyor stops precisely at an integer number of needle rows.

Additionally, the servo-system 608 for the needle assembly 104 allows the user to create custom injection profiles or select from predetermined profiles stored in the memory 604. For example, a user can control the rate of insertion or extraction of needles, the rate of ingredient injection, and the like. The user can select a vertical motion profile with slow insertion with fast extraction, uniform, or fast insertion with slow extraction, or anything in between, as needed for best product quality and best uniformity of treatment. Once a vertical motion profile is determined, the profile can be stored in the memory 604 for use on similar products.

Example of embodiments may include the following.

An embodiment includes an injection machine 100, comprising a needle assembly 104 including a plurality of injector needles 200 arranged into a pattern to cover a horizontal injection area, the injector needles include side exit ports 202 located proximally with respect to a tip of the needles; a conveyor 304 positioned below the needle assembly, wherein the conveyor includes perforations on a top surface of the conveyor, wherein the perforations allow the plurality of injector needles to be lowered to place the side exit ports of the injector needles at or just above the top surface of the conveyor.

In an embodiment, the conveyor is an endless loop belt conveyor.

In an embodiment, the tips of the injector needles travel below the top surface of the conveyor on a downstroke of the needle assembly.

In an embodiment, the injection machine 100 further comprises a control system 600 configured to control the forward advance speed of the conveyor and synchronize the lifting and lowering of the needle assembly with the advance of the conveyor.

In an embodiment, an injector needle is a hollow tube ending in a sharp tip, wherein the tip is closed, and the injector needle has a plurality of side exit port about 4 mm to about 5 mm proximally above the end of the tip and around the circumference of the injector needle.

In an embodiment, the perforations in the conveyor at least match the pattern of the plurality of injector needles.

In an embodiment, the conveyor includes perforations on the top surface in addition to perforations that match the pattern of the plurality of injector needles.

In an embodiment, the conveyor includes perforations on the top surface that match the patterns of two or more needle assembly patterns.

In an embodiment, the perforations in the conveyor are only as deep as a distance between the tip of the injector needle to an edge of the side exit port, and a horizontal dimension of the perforations are at least equal to or greater than a diameter of the injector needles.

In an embodiment, the injection machine 100 further comprises a control system 600 configured to control a timing of injecting fluid via the injector needles.

In an embodiment, a method of injection of an ingredient in a food product with an injection machine 100 comprising a needle assembly 104 including a plurality of injector needles 200 arranged into a pattern to cover a horizontal injection area, the injector needles include side exit ports 202 located proximally with respect to a tip of the needle and a conveyor belt 304 positioned below the needle assembly, wherein the conveyor belt includes perforations on the surface of the conveyor belt, the method comprising:

lowering the needle assembly during injection of the ingredient into the food product 206, wherein the perforations allow the plurality of injector needles to be lowered to place the side exit ports of the injector needles at or just above a top surface of the conveyor belt.

In an embodiment, the food product is a low profile food product.

In an embodiment, the ingredient includes brine, spices, flavors, marinade, or combination thereof.

In an embodiment, the method further comprises advancing the conveyor in increments of at least 100 mm.

In an embodiment, the method further comprises advancing the conveyor in increments of at least 200 mm.

In an embodiment, the method further comprises synchronizing the injection of ingredient into the food product with the advance of the conveyor belt.

In an embodiment, the method further comprises controlling dispensing of the ingredient from the side exit ports to include injection throughout a thickness of the food product including at the lower portions of the food product.

In an embodiment, a method of making an injection machine 100 that comprises a needle assembly 104 including a plurality of injector needles 200 arranged into a pattern to cover a horizontal injection area, the injector needles include side exit ports 202 located proximally with respect to a tip of the needle and a conveyor belt is positioned below the needle assembly, the method comprising:

replacing the conveyor belt with a conveyor belt 304 that includes perforations on the top surface of the conveyor belt, wherein the perforations allow the plurality of injector needles to be lowered to place the side exit ports of the injector needles at or just above the top surface of the conveyor belt.

In an embodiment, the conveyor includes a pattern of perforations on the top surface that match at least one pattern of injector needles of the needle assembly.

In an embodiment, perforations are added to the conveyor for retro-fitting of the injection machine.

In an embodiment, an injection machine 100 comprises a needle assembly 104 including a plurality of injector needles 200 configured to inject an ingredient into a food product over a horizontal area and throughout the thickness of the food product, wherein the needle assembly is configured to be lowered and raised; a conveyor 304 below the needle assembly, wherein a top surface of the conveyor allows the injector needles to be lowered partly below the top surface of the conveyor; and a control system 600 configured to advance the conveyor in increments corresponding to the horizontal area of the needle assembly.

In an embodiment, the control system is configured to lower the needle assembly according to a vertical motion profile for the needle assembly.

In an embodiment, the vertical motion profile can be adjusted to control the rate of insertion or extraction of the injector needles.

In an embodiment, the injector needles are arranged into one or more rows, and the conveyor advances in increments corresponding to the number of rows.

In an embodiment, the top surface of the conveyor includes perforations at least in a pattern corresponding to the injector needles.

In an embodiment, the injection machine 100, comprises a conveyor belt made of modular plastic lengths laced together with steel rods.

In an embodiment, the control system calculates the position of the conveyor based on detection of steel rods in the conveyor.

While illustrative embodiments have been illustrated and described, it will be appreciated that various changes can be made therein without departing from the spirit and scope of the invention.

1. An injection machine, comprising:
a needle assembly including a plurality of injector needles arranged into a pattern to cover a horizontal injection area, the injector needles include side exit ports located proximally with respect to a tip of the needles;
a conveyor positioned below the needle assembly, wherein the conveyor includes perforations on a top surface of the conveyor, wherein the perforations allow the plurality of injector needles to be lowered to place the side exit ports of the injector needles at or just above the top surface of the conveyor.

2. The injection machine of claim 1, wherein the conveyor is an endless loop belt conveyor.

3. The injection machine of claim 1, wherein the tips of the injector needles travel below the top surface of the conveyor on a downstroke of the needle assembly.

4. The injection machine of claim 1, further comprising a control system configured to control the forward advance speed of the conveyor and synchronize the lifting and lowering of the needle assembly with the advance of the conveyor.

5. The injection machine of claim 1, wherein an injector needle is a hollow tube ending in a sharp tip, wherein the tip is closed, and the injector needle has a plurality of side exit port about 4 mm to about 5 mm proximally above the end of the tip and around the circumference of the injector needle.

6. The injection machine of claim 1, wherein the perforations in the conveyor at least match the pattern of the plurality of injector needles.

7. The injection machine of claim 6, wherein the conveyor includes perforations on the top surface in addition to perforations that match the pattern of the plurality of injector needles.

8. The injection machine of claim 7, wherein the conveyor includes perforations on the top surface that match the patterns of two or more needle assembly patterns.

9. The injection machine of claim 1, wherein the perforations in the conveyor are only as deep as a distance between the tip of the injector needle to an edge of the side exit port, and a horizontal dimension of the perforations are at least equal to or greater than a diameter of the injector needles.

10. The injection machine of claim 1, further comprising a control system configured to control a timing of injecting fluid via the injector needles.

11. A method of injection of an ingredient in a food product with an injection machine comprising a needle assembly including a plurality of injector needles arranged into a pattern to cover a horizontal injection area, the injector needles include side exit ports located proximally with respect to a tip of the needle and a conveyor belt positioned below the needle assembly, wherein the conveyor belt includes perforations on the surface of the conveyor belt, the method comprising:
lowering the needle assembly during injection of the ingredient into the food product, wherein the perforations allow the plurality of injector needles to be lowered to place the side exit ports of the injector needles at or just above a top surface of the conveyor belt.

12. The method of claim 11, wherein the food product is a low profile food product.

13. The method of claim 11, wherein the ingredient includes brine, spices, flavors, marinade, or combination thereof.

14. The method of claim 11, further comprising advancing the conveyor in increments of at least 100 mm.

15. The method of claim 11, further comprising advancing the conveyor in increments of at least 200 mm.

16. The method of claim 11, further comprising synchronizing the injection of ingredient into the food product with the advance of the conveyor belt.

17. The method of claim 11, further comprising controlling dispensing of the ingredient from the side exit ports to include injection throughout a thickness of the food product including at the lower portions of the food product.

18. A method of making an injection machine that comprises a needle assembly including a plurality of injector needles arranged into a pattern to cover a horizontal injection area, the injector needles include side exit ports located proximally with respect to a tip of the needle and a conveyor belt is positioned below the needle assembly, the method comprising:
replacing the conveyor belt with a conveyor belt that includes perforations on the top surface of the conveyor belt, wherein the perforations allow the plurality of injector needles to be lowered to place the side exit ports of the injector needles at or just above the top surface of the conveyor belt.

19. The method of claim 18, wherein the conveyor includes a pattern of perforations on the top surface that match at least one pattern of injector needles of the needle assembly.

20. The method of claim 19, wherein perforations are added to the conveyor for retro-fitting of the injection machine.

21. An injection machine, comprising:
a needle assembly including a plurality of injector needles configured to inject an ingredient into a food product over a horizontal area and throughout the thickness of the food product, wherein the needle assembly is configured to be lowered and raised;
a conveyor below the needle assembly, wherein a top surface of the conveyor allows the injector needles to be lowered partly below the top surface of the conveyor; and
a control system configured to advance the conveyor in increments corresponding to the horizontal area of the needle assembly.

22. The injection machine of claim 21, wherein the control system is configured to lower the needle assembly according to a vertical motion profile for the needle assembly.

23. The injector machine of claim 21, wherein the vertical motion profile can be adjusted to control the rate of insertion or extraction of the injector needles.

24. The injection machine of claim 21, wherein the injector needles are arranged into one or more rows, and the conveyor advances in increments corresponding to the number of rows.

25. The injection machine of claim 21, wherein the top surface of the conveyor includes perforations at least in a pattern corresponding to the injector needles.

26. The injection machine of claim 21, comprising a conveyor belt made of modular plastic lengths laced together with steel rods.

27. The injection machine of claim 21, wherein the control system calculates the position of the conveyor based on detection of steel rods in the conveyor.
